(19) United States
(12) Patent Application Publication
(10) Pub. No.: US 2025/0023589 A1
(43) Pub. Date: Jan. 16, 2025

(54) WIRELESS COMMUNICATION METHOD AND DEVICE

(71) Applicant: GUANGDONG OPPO MOBILE TELECOMMUNICATIONS CORP., LTD., Dongguan (CN)

(72) Inventor: Rongyi HU, Dongguan (CN)

(21) Appl. No.: 18/901,116

(22) Filed: Sep. 30, 2024

Related U.S. Application Data
(63) Continuation of application No. PCT/CN2022/085566, filed on Apr. 7, 2022.

(51) Int. Cl. H04B 1/00; H04L 5/14; H04L 5/16

(52) U.S. Cl. CPC H04B 1/0064; H04L 5/143; H04L 5/16

(57) ABSTRACT

A wireless communication method includes: transmitting, by a first communication device, a first back scattering signal to a second communication device. The first communication device obtains power through power harvesting for communication, information harvesting and processing, and the second communication device operates in a full-duplex mode in an operating frequency band of the first back scattering signal.

### CROSS-REFERENCE TO RELATED APPLICATION

This application is a Continuation application of International Application No. PCT/CN2022/085566 filed on Apr. 7, 2022, which is incorporated herein by reference in its entirety.

### TECHNICAL FIELD

Embodiments of the present application relate to the field of communications, and more specifically, to a wireless communication method and a device.

### BACKGROUND

In zero-power communication, zero-power terminals need to harvest radio waves to obtain power before they may drive themselves to operate. For scenarios such as logistics warehousing management and supermarket shopping, a large number of zero-power terminals need to be connected. At present, it is necessary to expand the communication mechanism of zero-power devices.

### SUMMARY

The embodiments of the present application provide a wireless communication method and a device.

In a first aspect, a wireless communication method is provided, and the method includes:
transmitting, by a first communication device, a first back scattering signal to a second communication device;
where the first communication device obtains power through power harvesting for communication, information harvesting and processing, and the second communication device operates in a full-duplex mode in an operating frequency band of the first back scattering signal.

In a second aspect, a wireless communication method is provided, and the method includes:
receiving, by a second communication device, a first back scattering signal transmitted by a first communication device;
where the first communication device obtains power through power harvesting for communication, information harvesting and processing, and the second communication device operates in a full-duplex mode in an operating frequency band of the first back scattering signal.

In a third aspect, a wireless communication method is provided, and the method includes:
receiving, by a first communication device, a downlink signal of a first frequency band transmitted by a second communication device; and
transmitting, by the first communication device, an uplink signal of the first frequency band and a back scattering signal of a second frequency band to the second communication device;
where the first communication device obtains power through power harvesting for communication, information harvesting and processing, and the second communication device operates in a full-duplex mode in the first frequency band.

In a fourth aspect, a wireless communication method is provided, and the method includes:
transmitting, by a second communication device, a downlink signal of a first frequency band to a first communication device;
receiving, by the second communication device, an uplink signal of the first frequency band and a back scattering signal of a second frequency band that are transmitted by the first communication device;
where the first communication device obtains power through power harvesting for communication, information harvesting and processing, and the second communication device operates in a full-duplex mode in the first frequency band.

In a fifth aspect, a communication device is provided to perform the method in the above first aspect.

In some embodiments, the communication device includes a functional module configured to perform the method in the above first aspect.

In a sixth aspect, a communication device is provided to perform the method in the above second aspect.

In some embodiments, the communication device includes a functional module configured to perform the method in the above second aspect.

In a seventh aspect, a communication device is provided to perform the method in the above third aspect.

In some embodiments, the communication device includes a functional module configured to perform the method in the above third aspect.

In an eighth aspect, a communication device is provided to perform the method in the above fourth aspect.

In some embodiments, the communication device includes a functional module configured to perform the method in the above fourth aspect.

In a ninth aspect, a communication device is provided, including a processor and a memory. The memory is configured to store a computer program, and the processor is configured to call and run the computer program stored in the memory, to cause the communication device to perform the method in any one of the first to fourth aspects above.

In a tenth aspect, an apparatus is provided to implement the method in any one of the first to fourth aspects above.

In some embodiments, the apparatus includes: a processor, configured to call a computer program from a memory and run the computer program, to cause a device equipped with the apparatus to perform the method in any one of the first to fourth aspects above.

In an eleventh aspect, a non-transitory computer-readable storage medium is provided to store a computer program, and the computer program enables a computer to perform the method in any one of the first to fourth aspects above.

In a twelfth aspect, a computer program product is provided, including computer program instructions, and the computer program instructions enable a computer to perform the method in any one of the first to fourth aspects above.

In a thirteenth aspect, a computer program is provided, and when being executed on a computer, the computer program enables the computer to perform the method in any one of the first to fourth aspects above.

### BRIEF DESCRIPTION OF THE DRAWINGS

FIG. 1 is a schematic diagram of a communication system architecture applied in the embodiments of the present application.

FIG. 2 is a diagram showing a principle of zero-power communication provided by the present application.

FIG. 3 is a diagram showing a principle of back scattering communication provided by the present application.

FIG. 4 is a diagram showing a principle of power harvesting provided by the present application.

FIG. 5 is a circuit principle diagram of a resistive load modulation provided by the present application.

FIG. 6 is a schematic diagram of a low power consumption provided by the present application.

FIG. 7 is a schematic diagram of an envelope detection provided by the present application.

FIG. 8 is a schematic diagram of receiver radio frequency indicator requirements provided by the present application.

FIG. 9 is a schematic diagram of a receiver blocking provided by the present application.

FIG. 10 is a schematic flowchart diagram of a wireless communication method provided according to the embodiments of the present application.

FIG. 11 is a schematic diagram of a full-duplex communication architecture provided according to the embodiments of the present application.

FIG. 12 is a schematic diagram of another full-duplex communication architecture provided according to the embodiments of the present application.

FIG. 13 is a schematic diagram of yet another full-duplex communication architecture provided according to the embodiments of the present application.

FIG. 14 is a schematic diagram of still another full-duplex communication architecture provided according to the embodiments of the present application.

FIG. 15 is a schematic diagram of a back scattering provided in the present application.

FIG. 16 is a schematic flowchart diagram of another wireless communication method provided according to the embodiments of the present application.

FIG. 17 is a schematic diagram of yet still another full-duplex communication architecture provided according to the embodiments of the present application.

FIG. 18 is a schematic diagram of yet still another full-duplex communication architecture provided according to the embodiments of the present application.

FIG. 19 is a schematic block diagram of a communication device provided according to the embodiments of the present application.

FIG. 20 is a schematic block diagram of another communication device provided according to the embodiments of the present application.

FIG. 21 is a schematic block diagram of an apparatus provided according to the embodiments of the present application.

FIG. 22 is a schematic block diagram of a communication system provided according to the embodiments of the present application.

### DETAILED DESCRIPTION

The technical solutions of the embodiments of the present application will be described below in conjunction with the drawings in the embodiments of the present application. Obviously, the described embodiments are merely some but not all of the embodiments of the present application. All other embodiments obtained based on the embodiments of the present application by the ordinary skilled in the art shall belong to the protection scope of the present application.

The technical solutions of the embodiments of the present application may be applied to various communication systems, such as: a global system of mobile communication (GSM) system, a code division multiple access (CDMA) system, a wideband code division multiple access (WCDMA) system, a general packet radio service (GPRS), a long term evolution (LTE) system, an advanced long term evolution (LTE-A) system, a new radio (NR) system, an NR system evolution system, an LTE-based access to unlicensed spectrum (LTE-U) system, an NR-based access to unlicensed spectrum (NR-U) system, a non-terrestrial networks (NTN) system, a universal mobile telecommunication system (UMTS), a wireless local area networks (WLAN), internet of things (IoT), a wireless fidelity (WiFi), a 5th-Generation (5G) system or other communication systems.

Generally speaking, traditional communication systems support a limited number of connections and are easy to be implemented. However, with the development of communication technologies, mobile communication systems will not only support traditional communications, but will also support, for example, device to device (D2D) communication, machine to machine (M2M) communication, machine type communication (MTC), vehicle to vehicle (V2V) communication, vehicle to everything (V2X) communication, or the like. The embodiments of the present application may also be applied to these communication systems.

In some embodiments, a communication system in the embodiments of the present application may be applied to a carrier aggregation (CA) scenario, a dual connectivity (DC) scenario, a standalone (SA) networking scenario, or a non-standalone (NSA) networking scenario.

In some embodiments, the communication system in the embodiments of the present application may be applied to an unlicensed spectrum, where the unlicensed spectrum may also be considered as a shared spectrum; or the communication system in the embodiments of the present application may also be applied to a licensed spectrum, where the licensed spectrum may also be considered as an unshared spectrum.

In some embodiments, the communication system in the embodiments of the present application may be applied to an FR1 frequency band (corresponding to a frequency band range of 410 MHz to 7.125 GHZ), as well as to an FR2 frequency band (corresponding to a frequency band range of 24.25 GHz to 52.6 GHZ), and may also be applied to a new frequency band such as a high-frequency frequency band corresponding to a frequency band range of 52.6 GHz to 71 GHz or corresponding to the frequency band range of 71 GHz to 114.25 GHZ.

The embodiments of the present application describe various embodiments in conjunction with a network device and a terminal device, where the terminal device may also be referred to as a user equipment (UE), an access terminal, a user unit, a user station, a mobile station, a mobile platform, a remote station, a remote terminal, a mobile device, a user terminal, a terminal, a wireless communication device, a user agent, a user apparatus, or the like.

The terminal device may be a station (STATION, STA) in the WLAN, which may be a cellular phone, a cordless phone, a session initiation protocol (SIP) phone, a wireless local loop (WLL) station, a personal digital assistant (PDA) device, a handheld device with a wireless communication function, a computing device or another processing device connected to a wireless modem, a vehicle-mounted device, a wearable device, a terminal device in a next-generation communication system (such as in an NR network), a terminal device in a public land mobile network (PLMN) network evolved in the future, or the like.

In the embodiments of the present application, the terminal device may be deployed on land, including indoors or outdoors, in handheld, wearable or vehicle-mounted, may also be deployed on the water surface (e.g., on a ship, etc.), and may also be deployed in the air (e.g., on an airplane, a balloon, a satellite, or the like).

In the embodiments of the present application, the terminal device may be a mobile phone, a pad, a computer with a wireless transmit-receive function, a virtual reality (VR) terminal device, an augmented reality (AR) terminal device, a wireless terminal device in industrial control, a wireless terminal device in self driving, a wireless terminal device in remote medical, a wireless terminal device in a smart grid, a wireless terminal device in transportation safety, a wireless terminal device in smart city or in smart home, an vehicle-mounted communication device, a wireless communication chip/application specific integrated circuit (ASIC)/system on chip (SoC), or the like.

By way of example and without limitation, in the embodiments of the present application, the terminal device may also be a wearable device. The wearable device may also be called a wearable smart device, is a general term for the intelligent design and development of a wearable device for daily wear using wearable technology, such as glasses, gloves, watches, clothing and shoes. A wearable device is a portable device that can be worn directly on the body or integrated into the user's clothing or accessories. The wearable device is not just a hardware device, but also implements powerful functions through software support, data interaction, and cloud interaction. In a broad sense, wearable smart devices include devices with full functions, large size, and all or part of functions without relying on smartphones, such as smart watches or smart glasses, as well as, devices that only focus on a certain type of application function and need to be used in conjunction with other devices, such as smart bracelets or smart jewelry for physical sign monitoring.

In the embodiments of the present application, the network device may be a device used for communicating with a mobile device. The network device may be an access point (AP) in the WLAN, a base station (Base Transceiver Station, BTS) in the GSM or CDMA, or may be a base station (NodeB, NB) in the WCDMA, or may be an evolutionary base station (Evolutional Node B, eNB or eNodeB) in the LTE, or a relay station or an access point, or a vehicle-mounted device, a wearable device, and a network device or a base station (gNB) in an NR network, or a network device in the PLMN network evolved in the future, or a network device in the NTN network. By way of example and without limitation, in the embodiments of the present application, the network device may have a mobile characteristic, for example, the network device may be a mobile device. In some embodiments, the network device may be a satellite or a balloon station. For example, the satellite may be a low earth orbit (LEO) satellite, a medium earth orbit (MEO) satellite, a geostationary earth orbit (GEO) satellite, a high elliptical orbit (HEO) satellite, or the like. In some embodiments, the network device may also be a base station located on land, water, and other places.

In the embodiments of the present application, the network device may provide a service for a cell, and the terminal device communicates with the network device through a transmission resource (such as a frequency domain resource, or a spectrum resource) used by the cell. The cell may be a cell corresponding to the network device (such as the base station), the cell may belong to a macro base station or may also be a base station corresponding to a small cell. Here, small cells may include: a metro cell, a micro cell, a pico cell, a femto cell, etc., these small cells have characteristics of small coverage range and low transmission power, which are applicable for providing a data transmission service with high speed.

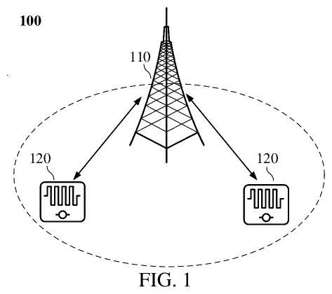

For example, a communication system 100 used in the embodiments of the present application is shown in FIG. 1. The communication system 100 may include a network device 110, and the network device 110 may be a device for communicating with a terminal device 120 (or referred to as a communication terminal or terminal). The network device 110 may provide communication coverage for a specific geographical area and may communicate with the terminal device located within the coverage area.

FIG. 1 exemplarily shows one network device and two terminal devices. In some embodiments, the communication system 100 may include multiple network devices, and the coverage area of each network device may include another number of terminal devices, which is not limited in the embodiments of the present application.

In some embodiments, the communication system 100 may further include other network entities such as a network controller and a mobility management entity, which is not limited in the embodiments of the present application.

It should be understood that a device having a communication function in a network/system in the embodiments of the present application may be referred to as a communication device. Taking the communication system 100 shown in FIG. 1 as an example, communication devices may include a network device 110 and a terminal device 120 that have communication functions. The network device 110 and the terminal device 120 may be the exemplary devices described above and will not be repeated here; and the communication device may further include other devices in the communication system 100, e.g., other network entities such as a network controller and a mobile management entity, which is not limited in the embodiments of the present application.

It should be understood that the terms “system” and “network” are often used interchangeably herein. The term “and/or” here is merely a description of the association relationship of associated objects, and indicates that three relationships may exist. For example, A and/or B may mean: A alone, A and B both, and B alone. Moreover, the character “/” herein generally indicates that the associated objects before and after this character are in an “or” relationship.

It should be understood that a first communication device and a second communication device are involved herein. The first communication device may be a terminal device, such as a mobile phone, a machine facility, a customer premise equipment (CPE), an industrial device, a vehicle, or the like; and the second communication device may be a counterpart communication device of the first communication device, such as a network device, a mobile phone, an industrial equipment, a vehicle, or the like. The first communication device being a terminal device and the second communication device being a network device are described herein as an example.

The terms used in the implementation section of the present application are merely used to explain the embodiments of the present application and are not intended to limit the present application. The terms “first”, “second” and the like in the specification, claims and drawings of the present application are used to distinguish different objects rather than to describe a specific order. In addition, the terms “include”, “comprises”, and “have,” and any variations thereof, are intended to cover a non-exclusive inclusion.

It should be understood that the “indicate” mentioned in the embodiments of the present application may mean a direct indication or an indirect indication, or represent that there is an associated relationship. For example, A indicates B, which may mean that A directly indicates B, e.g., B may be obtained through A; A indirectly indicates B, e.g., A indicates C, and B may be obtained through C; or there is an association relationship between A and B.

In the description of the embodiments of the present application, the term “corresponding” may indicate a direct or indirect correspondence between two items, or an association relationship between the two items, or a relationship of indicating and being indicated, a relationship of configuring and being configured, etc.

In the embodiments of the present application, “pre-defined” or “pre-configured” may be implemented by pre-saving corresponding codes, tables or other methods that can be used to indicate relevant information in a device (e.g., including a terminal device and a network device). The present application does not limit its implementation method. For example, being pre-defined may mean being defined in the protocol.

In the embodiments of the present application, the “protocol” may refer to a standard protocol in the communication field, for example, it may include an LTE protocol, an NR protocol, and related protocols applied in future communication systems, and the present application does not limit this.

To facilitate understanding of the technical solutions of the embodiments of the present application, the technical solutions of the present application are described in detail below through embodiments. The following related technologies may be arbitrarily combined with the technical solutions of the embodiments of the present application as optional solutions, and they all belong to the protection scope of the embodiments of the present application. The embodiments of the present application include at least part of the following contents.

In recent years, applications of zero-power devices (Ambient based IoT, A-IoT) have become more and more widespread. A typical zero-power device is radio frequency identification (RFID), which uses wireless radio frequency signal spatial coupling to implement contactless automatic transmission and identification of tag information. RFID tag is also called a “radio frequency tag” or an “electronic tag”. According to different power supply methods, types of electronic tags may be divided into active electronic tags, passive electronic tags and semi-passive electronic tags. Active electronic tags, also known as initiative electronic tags, are tags whose operating power is provided by a battery. The battery, memory and antenna together constitute an active electronic tag, and different from a passive radio frequency activation method, the active electronic tag transmits information through a set frequency band until the battery is replaced. Passive electronic tags, also known as non-initiative electronic tags, do not support built-in batteries. When approaching a reader/writer, a passive electronic tag is in a near field formed by the radiation of the reader/writer antenna, the electronic tag antenna generates an induced current through electromagnetic induction, and the induced current drives a chip circuit of the electronic tag. The chip circuit transmits identification information stored in the tag to the reader/writer through the electronic tag antenna. Semi-active electronic tags inherit the advantages of passive electronic tags, such as a small size, a light weight, a low price and a long service life, the built-in battery only provides power for a small number of circuits in the chip when there is no reader/writer access, and only when the reader/writer accesses, the built-in battery supplies power to the RFID chip to increase a reading and writing distance of the tag and improve the reliability of communication.

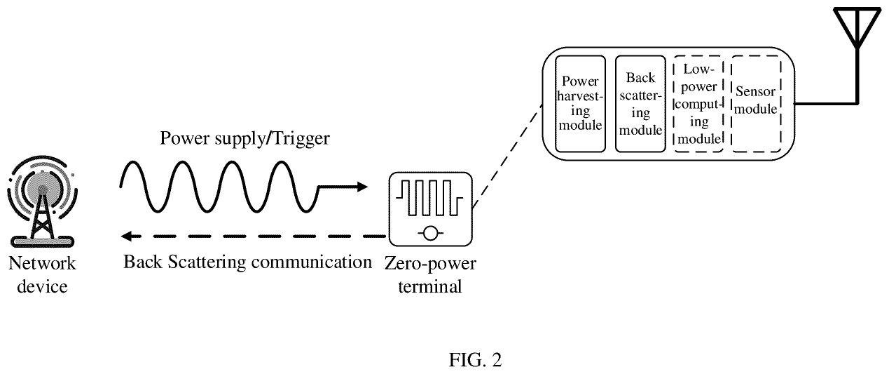

The RFID is a wireless communication technology. The most basic RFID system consists of two parts: an electronic tag (TAG) and a reader/writer (Reader/Writer). The electronic tag: it is composed of a coupling component and a chip. Each electronic tag has a unique electronic code and is placed on a target to be measured to achieve the purpose of marking the target object. The reader/writer: it can not only read information on the electronic tag, but also write the information on the electronic tag, and provide the electronic tag with the power required for communication. As shown in FIG. 2. After entering the electromagnetic field, the electronic tag receives a radio frequency signal transmitted by the reader/writer, the passive electronic tag or the passive electronic tag uses the power obtained from the electromagnetic field generated in the space to transmit the information stored in the electronic tag. The reader/writer reads the information and decodes it to identify the electronic tag.

The key technologies of zero-power communication include power harvesting and back scattering communication as well as low-power computing. As shown in FIG. 2, a typical zero-power communication system includes a reader/writer and a zero-power terminal. The reader/writer transmits a radio wave to provide power to the zero-power terminal. A power harvesting module installed at the zero-power terminal may harvest the power carried by the radio wave in space (the radio wave transmitted by the reader/writer is shown in FIG. 2) to drive a low-power computing module of the zero-power terminal and implement the back scattering communication. After obtaining power, the zero-power terminal may receive a control signaling from the reader/writer, and transmit data to the reader/writer based on the control signaling and back scattering. The data transmitted may come from data stored in the zero-power terminal itself (such as an identification or pre-written information, such as production date, brand, manufacturer, etc., of the product). The zero-power terminal may also be loaded with various sensors, so as to report the data harvested by the various sensors based on the zero-power mechanism.

To facilitate understanding the embodiments of the present application, back scattering communication (Back Scattering) related to the present application is explained.

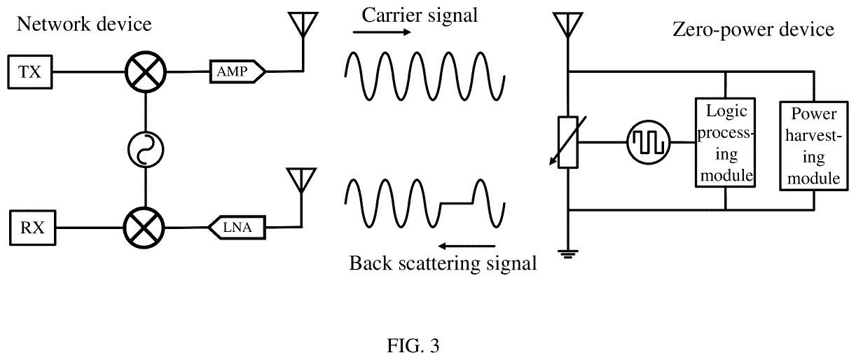

As shown in FIG. 3, a zero-power device (a back scattering tag in FIG. 3) receives a carrier signal transmitted by a back scattering reader/writer, and harvests power through a wireless radio frequency (RF) power harvesting module. Then the low-power processing module (logic processing module in FIG. 3) is powered by the power harvesting module to modulate an incoming signal and perform back scattering.

The main features of the back scattering communication are as follows:
(1) that a terminal does not actively transmit a signal, but implement the back scattering by modulating the incoming signal;
(2) that the terminal does not rely on a traditional active power amplifier transmitter and uses a low-power computing unit, greatly reducing hardware complexity; and
(3) that battery-free communication may be implemented in combination with power harvesting.

In order to facilitate a better understanding of the embodiments of the present application, an RF power harvesting related to the present application is explained.

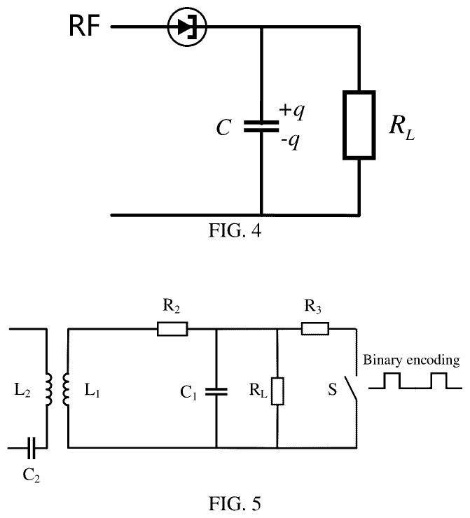

As shown in FIG. 4, the RF module is used to harvest the power of electromagnetic waves in space through electromagnetic induction, and then drive a load circuit (low-power computing, sensor, etc.), which may achieve battery-free operation.

In order to facilitate a better understanding of the embodiments of the present application, the load modulation related to the present application is explained.

Load modulation is a method often used by an electronic tag to transmit data to a reader/writer. Load modulation completes the modulation process by adjusting electrical parameters of the electronic tag oscillation circuit according to the rhythm of a data stream, to change the magnitude and phase of the electronic tag impedance accordingly. There are two main types of load modulation technology: resistive load modulation and capacitive load modulation. In the resistive load modulation, a resistor is connected in parallel with the load, called a load modulation resistor, which is turned on and off according to the clock of the data stream, and the on and off of a switch S is controlled by the binary data encoding. The equivalent circuit diagram of the resistive load modulation is shown in FIG. 5.

In the capacitive load modulation, a capacitor is connected in parallel with the load, replacing the load modulation resistor controlled by the binary data encoding in FIG. 5.

In order to facilitate a better understanding of the embodiments of the present application, the encoding technology related to the present application is explained.

The data transmitted by the electronic tag may use different forms of codes to represent binary “1” and “0”. Wireless RFID system usually use one of the following encoding methods: non-return-to-zero (NRZ) encoding, Manchester encoding, unipolar return-to-zero (Unipolar RZ) encoding, differential bi-phase (DBP) encoding, Miller encoding, and differential encoding. In layman's terms, different pulse signals are used to represent 0 and 1.

In order to facilitate a better understanding of the embodiments of the present application, a power supply signal in the zero-power communication system related to the present application is explained.

From the perspective of a power supply signal carrier, the power supply signal carrier may be a base station, a smart phone, a smart gateway, a charging station, a micro base station, or the like.

From the perspective of a frequency band, a radio wave used for power supply may be in low frequency, medium frequency, high frequency, or the like.

From the perspective of waveform, the radio wave used for power supply may be a sine wave, a square wave, a triangle wave, a pulse, a rectangular wave, or the like. In addition, the radio wave used for power supply may be a continuous wave or a non-continuous wave (i.e., a certain period of interruption is allowed).

The power supply signal may be a signal specified in the 3rd Generation Partnership Project (3GPP) standard, for example, a sounding reference signal (SRS), a physical uplink shared channel (PUSCH), a physical random access channel (PRACH), a physical uplink control channel (PUCCH), a physical downlink control channel (PDCCH), a physical downlink shared channel (PDSCH), a physical broadcast channel (PBCH), or the like.

In order to facilitate a better understanding of the embodiments of the present application, a trigger signal in the zero-power communication system related to the present application is explained.

From the perspective of a trigger signal carrier, the trigger signal carrier may be a base station, a smart phone, a smart gateway, or the like.

From the perspective of a frequency band, a radio wave used for power supply may be in low frequency, medium frequency, high frequency, or the like.

From the perspective of waveform, the radio wave used for power supply may be a sine wave, a square wave, a triangle wave, a pulse, a rectangular wave, or the like. In addition, the radio wave used for power supply may be a continuous wave or a non-continuous wave (i.e., a certain period of interruption is allowed).

The power supply signal may be a signal specified in the 3GPP standard, for example, an SRS, a PUSCH, a PRACH, a PUCCH, a PDCCH, a PDSCH, a PBCH, or the like.

In order to facilitate a better understanding of the embodiments of the present application, the classification of zero-power terminals related to the present application is explained.

Based on the power source and usage of zero-power terminals, zero-power terminals may be divided into the following types:

### 1) Passive Zero-Power Terminal

The zero-power terminal does not need a built-in battery. When the zero-power terminal approaches a network device (such as a reader/writer of an RFID system), the zero-power terminal is within a near field formed by an antenna radiation of the network device. Therefore, the zero-power terminal antenna generates an induced current through electromagnetic induction, and the induced current drives the low-power chip circuit of the zero-power terminal. In this way, operations such as demodulation of a forward link signal and modulation of a reverse link signal can be implemented. For a back scattering link, the zero-power terminal uses the back scattering implementation for signal transmission.

It can be seen that the passive zero-power terminal does not require a built-in battery to drive either the forward link or the reverse link, and is a true zero-power terminal.

The passive zero-power terminal does not require a battery, and an RF circuit and baseband circuit therein are very simple. For example, the passive zero-power terminal does not require a low-noise amplifier (LNA), a power amplifier (PA), a crystal oscillator, an analog-to-digital converter (ADC) and other devices, and therefore has many advantages such as a small size, a light weight, a very low price, and a long service life.

### 2) Semi-Passive Zero-Power Terminal

The semi-passive zero-power terminal itself does not have a conventional battery installed thereon, but may use an RF power harvesting module to harvest radio wave power and store the harvested power in a power storage unit (such as a capacitor). After obtaining power, the power storage unit may drive a low-power chip circuit of this zero-power terminal. In this way, operations such as demodulation of a forward link signal and modulation of a reverse link signal can be implemented. For a back scattering link, the zero-power terminal uses the back scattering implementation for signal transmission.

It can be seen that the semi-passive zero-power terminal does not require a built-in battery to drive either the forward link or the reverse link. Although power stored in the capacitor is used in operation, the power comes from the radio power harvested by the power harvesting module. Therefore, the semi-passive zero-power terminal is also a true zero-power terminal.

The semi-passive zero-power terminal inherits many advantages of the passive zero-power terminal, and therefore has many advantages such as a small size, a light weight, a very low price, and a long service life.

### 3) Active Zero-Power Terminal

The zero-power terminal used in some scenarios may also be an active zero-power terminal, which may have a built-in battery. The battery is used to drive the low-power chip circuit of the zero-power terminal. In this way, operations such as demodulation of a forward link signal and modulation of a reverse link signal can be implemented. However, for a back scattering link, the zero-power terminal uses the back scattering implementation for signal transmission. Therefore, the zero-power of this type of terminal is mainly reflected in the fact that the signal transmission of the reverse link does not require the terminal's own power, but uses the back scattering method.

The active zero-power terminal with the built-in battery to power the RFID chip to increase the reading and writing distance of the tag and improve the reliability of communication. Therefore, it may be applied in some scenarios with relatively high requirements on communication distance, reading delay, etc.

In order to facilitate a better understanding of the embodiments of the present application, cellular passive Internet of Things related to the present application is explained.

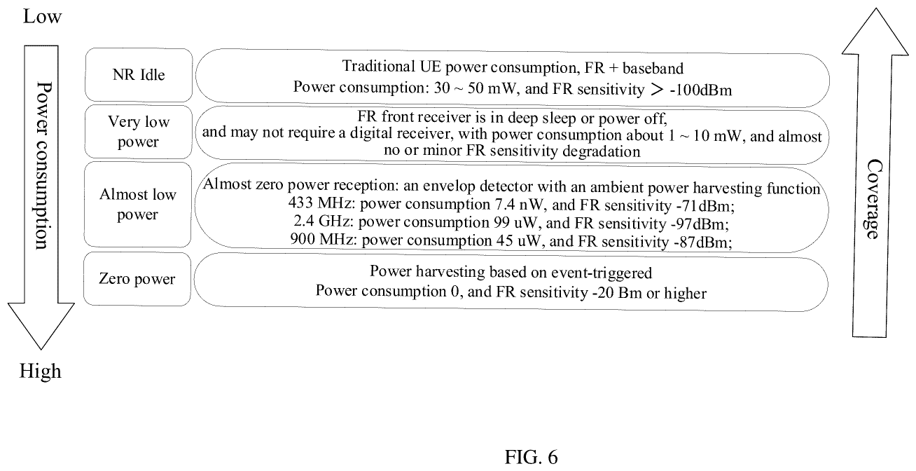

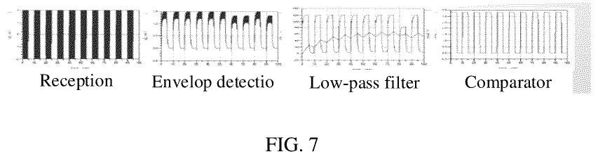

As 5G industry applications increase, the types of connected objects and application scenarios are increasingly numerous, and there will be higher requirements on the price and power of communication terminals. Applications of battery-free, low-cost passive Internet of Things devices will become a key technology for cellular Internet of Things, enriching the types and number of 5G network-connected terminals and truly realizing the Internet of Everything. Passive Internet of Things devices may be based on existing zero-power devices, such as RFID technology, and extended on this basis to be applied for cellular Internet of Things. As shown in FIG. 6, there are NR Idle: in which radio frequency and baseband are still operating; very low power: in which the main RF module is dormant or turned off; almost zero power: in which the switch of the main RF and baseband modules is determined by envelope detection of the activation or wake up signal (from the RF module), where the envelope detection may be shown in FIG. 7; and zero power: in which external radio frequency or other power is harvested to meet circuit consumption and communication needs.

In order to facilitate a better understanding of the embodiments of the present application, the coexistence of the zero-power terminal (or Ambient based IoT, A-IoT) related to the present application and the traditional communication is explained.

Referring to a system coexistence mode of narrowband Internet of Things, there may be three system coexistence modes between the zero-power terminal (or A-IoT) and NR: an in-band deployment mode, a guard band deployment mode and an independent deployment mode. Since the receiver sensitivity of traditional 4G/5G terminals is much lower than that of zero-power terminals, it is very necessary to study the coexistence and interference problems between zero-power communication systems and existing 4G/5G cellular communication networks.

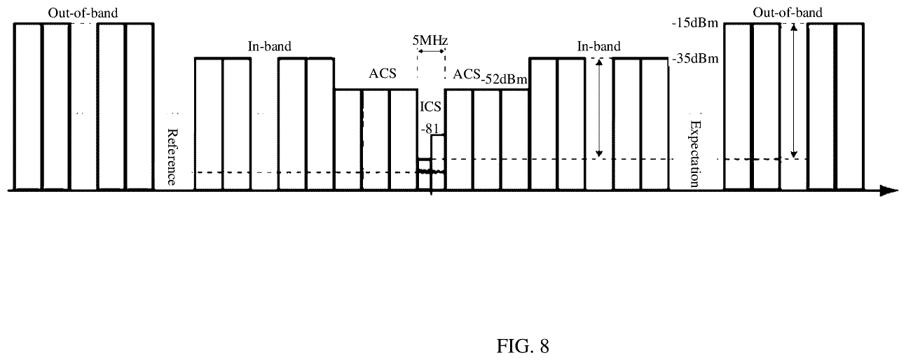

From the aforementioned characteristics of power harvesting and back scattering of the zero-power device, it may be found that the most important thing in the coexistence study of zero-power communication systems and existing 4G/5G systems is to analyze the impact of coexistence on the receiver performance of the two, including in-channel sensitivity (ICS), maximum input level, adjacent channel selectivity (ACS), blocking (in-band, out-of-band and narrow-band blocking) and spurious response and other indicators. FIG. 8 is a schematic diagram of basic receiver radio frequency indicator requirements.

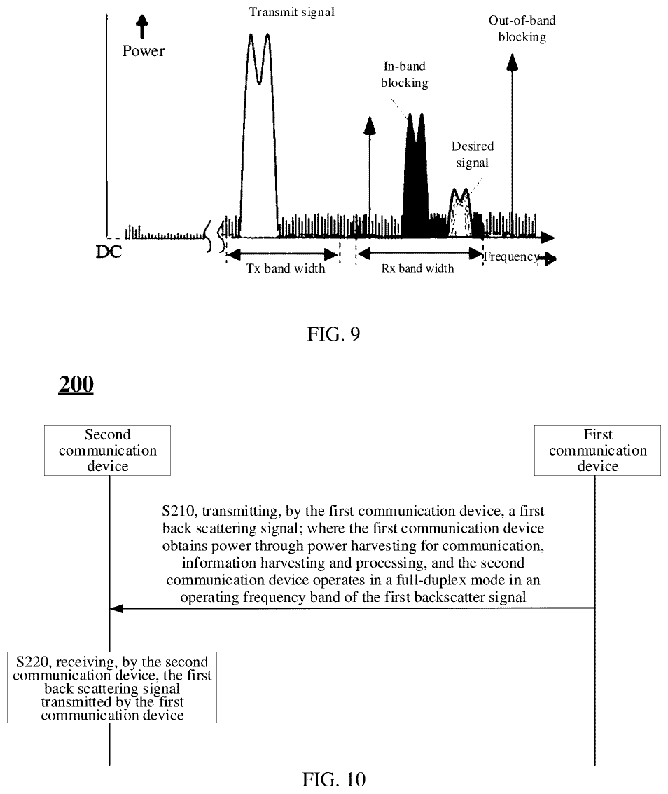

Regardless of whether the zero-power device is deployed in an in-band mode, a guard band mode or an independent mode, the downlink signal transmitted to the zero-power terminal or the reflected signal of the zero-power terminal may also fall into the adjacent band or in-band of the 4G/5G terminal, causing adjacent-band interference or in-band blocking, as shown in FIG. 9. In this case, the interference signal should meet the receiver radio frequency indicator requirements of the 4G/5G terminal, otherwise it will reduce the receiver performance, causing the receiver sensitivity to decline (MSD).

In particular, if the in-band mode is adopted, it is first necessary to avoid co-frequency interference between systems, that is, in-band interference. Current research has found that the input power of wireless power harvesting of the zero-power terminal is generally at least −20 dBm. It is necessary to evaluate whether the transmitted signal and back scattering signal of the power source will cause co-frequency interference to other 4G/5G terminals on the same frequency band. For example, from the perspective of wireless power supply, the network needs to transmit a relatively strong signal so that the reception power of the zero-power terminal is above −20 dBm. Such a strong signal may affect the maximum input power of an existing terminal when using the in-band deployment mode. For example, the maximum input power required by the existing protocol is −15 dBm. Therefore, it is necessary to evaluate the impact on the existing terminal and how to avoid the related impact.

If the zero-power device is deployed together with the 4G/5G terminal, the coexistence problem will be more complicated. It is further necessary to consider the additional interference caused by signals such as a harmonic and an intermodulation, and their impact on the performance of the receivers of both. In addition, there are also coexistence issues with other systems such as WiFi, Bluetooth, BeiDou global positioning system (GPS), etc., which also need to be analyzed more specifically based on the actual operating frequency bands and modes. If the zero-power device exists in the form of an independent device, the above coexistence problem will be much simpler, and it only needs to meet the radio frequency indicator requirements of the above transmitter/receiver adjacent band and out-of-band spurious radiation.

At present, it is necessary to expand the communication mechanism of the zero-power device. In light of this, the present application provides technical solutions for wireless communication. A full-duplex communication device serves as a receiving device for the back scattering signal of the zero-power device, which may operate in a full-duplex mode in an operating frequency band of the back scattering signal, and/or in a full-duplex mode in an operating frequency band of a power supply/wake up signal, thereby realizing a zero-power device communication mechanism under a full-duplex communication architecture, and expanding practical application deployment.

In the embodiments, a wireless communication method is provided, which includes:
transmitting, by a first communication device, a first back scattering signal to a second communication device;
where the first communication device obtains power through power harvesting for communication, information harvesting and processing, and the second communication device operates in a full-duplex mode in an operating frequency band of the first back scattering signal.

In some embodiments, the method further includes:
receiving, by the first communication device, a first carrier signal transmitted by the second communication device;
where the first back scattering signal is generated by modulating the first carrier signal.

In some embodiments, the method further includes:
receiving, by the first communication device, a first power supply signal transmitted by the second communication device, where an operating frequency band of the first power supply signal is different from the operating frequency band of the first back scattering signal.

In some embodiments, the method further includes:
receiving, by the first communication device, a second carrier signal transmitted by the second communication device; and
transmitting, by the first communication device, a second back scattering signal to the second communication device, where the second back scattering signal is generated by modulating the second carrier signal, and an operating frequency band of the second back scattering signal is different from the operating frequency band of the first back scattering signal.

In some embodiments, the first back scattering signal and the second back scattering signal are transmitted via carrier aggregation.

In some embodiments, the first carrier signal and the second carrier signal are transmitted via carrier aggregation.

In some embodiments, an operating frequency band of the second carrier signal is the same as the operating frequency band of the first power supply signal.

In some embodiments, the method further includes:
receiving, by the first communication device, a second power supply signal transmitted by the second communication device, where an operating frequency of the first back scattering signal is determined according to an operating frequency of the second power supply signal; and
transmitting, by the first communication device, a third back scattering signal to the second communication device, where a carrier of the third back scattering signal includes a harmonic signal of the first power supply signal.

In some embodiments, the second communication device operates in a half-duplex mode in an operating frequency band of the third back scattering signal.

In some embodiments, the first communication device includes a back scattering transmitter, where the first back scattering signal is transmitted by the back scattering transmitter.

In the embodiments, a wireless communication method is provided, which includes:
receiving, by a second communication device, a first back scattering signal transmitted by a first communication device;
where the first communication device obtains power through power harvesting for communication, information harvesting and processing, and the second communication device operates in a full-duplex mode in an operating frequency band of the first back scattering signal.

In some embodiments, the method further includes:
transmitting, by the second communication device, a first carrier signal to the first communication device;
where the first back scattering signal is generated by modulating the first carrier signal.

In some embodiments, the method further includes:
transmitting, by the second communication device, a first power supply signal to the first communication device, where an operating frequency band of the first power supply signal is different from the operating frequency band of the first back scattering signal.

In some embodiments, the method further includes:
transmitting, by the second communication device, a second carrier signal to the first communication device; and
receiving, by the second communication device, a second back scattering signal transmitted by the first communication device, where the second back scattering signal is generated by modulating the second carrier signal, and an operating frequency band of the second back scattering signal is different from the operating frequency band of the first back scattering signal.

In some embodiments, the first back scattering signal and the second back scattering signal are transmitted via carrier aggregation.

In some embodiments, the first carrier signal and the second carrier signal are transmitted via carrier aggregation.

In some embodiments, an operating frequency band of the second carrier signal is the same as the operating frequency band of the first power supply signal.

In some embodiments, the method further includes:
transmitting, by the second communication device, a second power supply signal to the first communication device, where an operating frequency of the first back scattering signal is determined according to an operating frequency of the second power supply signal; and
receiving, by the second communication device, a third back scattering signal transmitted by the first communication device, where a carrier of the third back scattering signal includes a harmonic signal of the first power supply signal.

In some embodiments, the second communication device operates in a half-duplex mode in an operating frequency band of the third back scattering signal.

In some embodiments, the first communication device includes a back scattering transmitter, where the first back scattering signal is transmitted by the back scattering transmitter.

In the embodiments, a wireless communication method is provided, which includes:
receiving, by a first communication device, a downlink signal of a first frequency band transmitted by a second communication device; and
transmitting, by the first communication device, an uplink signal of the first frequency band and a back scattering signal of a second frequency band to the second communication device;
where the first communication device obtains power through power harvesting for communication, information harvesting and processing, and the second communication device operates in a full-duplex mode in the first frequency band.

In some embodiments, the first communication device includes a normal transmitter, where a carrier of the back scattering signal includes a modulated signal transmitted by the normal transmitter.

In some embodiments, a carrier of the back scattering signal includes an interference signal generated by the downlink signal in the first communication device.

In some embodiments, the method further includes:
receiving, by the first communication device, a carrier signal of the second frequency band transmitted by the second communication device, where the back scattering signal is generated by modulating the carrier signal, and the carrier signal includes an interference signal of the downlink signal.

In some embodiments, there is a frequency offset between the back scattering signal and the interference signal.

In some embodiments, the frequency offset is greater than or equal to a unit of frequency guard band or a bandwidth of an occupied channel.

In some embodiments, the first communication device includes a back scattering transmitter, where the back scattering signal is transmitted by the back scattering transmitter.

In some embodiments, the interference signal includes a harmonic signal.

In some embodiments, the downlink signal includes a power supply signal and/or a wake up signal.

In the embodiments, a wireless communication method is provided, which includes:
transmitting, by a second communication device, a downlink signal of a first frequency band to a first communication device; and
receiving, by the second communication device, an uplink signal of the first frequency band and a back scattering signal of a second frequency band that are transmitted by the first communication device;
where the first communication device obtains power through power harvesting for communication, information harvesting and processing, and the second communication device operates in a full-duplex mode in the first frequency band.

In some embodiments, the first communication device includes a normal transmitter, where a carrier of the back scattering signal includes a modulated signal transmitted by the normal transmitter.

In some embodiments, a carrier of the back scattering signal includes an interference signal generated by the downlink signal in the first communication device.

In some embodiments, the method further includes:
transmitting, by the second communication device, a carrier signal of the second frequency band to the first communication device, where the back scattering signal is generated by modulating the carrier signal, and the carrier signal includes an interference signal of the downlink signal.

In some embodiments, there is a frequency offset between the back scattering signal and the interference signal.

In some embodiments, the frequency offset is greater than or equal to a unit of a frequency guard band or a bandwidth of an occupied channel.

In some embodiments, the first communication device includes a back scattering transmitter, where the back scattering signal is transmitted by the back scattering transmitter.

In some embodiments, the interference signal includes a harmonic signal.

In some embodiments, the downlink signal includes a power supply signal and/or a wake up signal.

The technical solutions of the present application are described in detail below through some embodiments.

FIG. 10 is a schematic flowchart of a wireless communication method 200 according to the embodiments of the present application. As shown in FIG. 10, the wireless communication method 200 may include at least part of the following contents:

S210, transmitting, by a first communication device, a first back scattering signal to a second communication device; where the first communication device obtains power through power harvesting for communication, information harvesting and processing, and the second communication device operates in a full-duplex mode in an operating frequency band of the first back scattering signal, i.e., supports full-duplex; and

S220, receiving, by the second communication device, the first back scattering signal transmitted by the first communication device.

In the embodiments of the present application, the second communication device operates in the full-duplex mode in the operating frequency band of the first back scattering signal, that is, the second communication device supports simultaneous transmitting and receiving of a signal in the operating frequency band of the first back scattering signal, thereby realizing a zero-power device communication mechanism under a full-duplex communication architecture, and expanding practical application deployment.

As a possible implementation, the transmitting antenna and receiving antenna of the second communication device may be physically isolated, for example, the transmitting antenna and receiving antenna of the same frequency band are respectively set at two distant physical positions on the antenna panel, so that the second communication device operates in the full-duplex mode in this frequency band.

Optionally, the first communication device may operate in the full-duplex mode or half-duplex mode in the operating frequency band of the first back scattering signal, without limitation.

In the embodiments of the present application, the first communication device may be a zero-power device or a tag device based on radio frequency power harvesting. Exemplarily, the first communication device may have only a back scattering transmitter (Tx) and a simple receiver (Rx), such as an A-IoT device; or the back scattering transmitter (Tx) and simple receiver (Rx) functions or modules may be attached to a normal transceiver terminal, such as an A-IoT assisted UE. That is, the first communication device may be a UE or an IoT device, and may have at least one of a wake up radio/receiver, a normal receiver, a back scattering transmitter, or a normal transmitter.

In some embodiments, the first back scattering signal is transmitted by the back scattering transmitter in the first communication device.

In the embodiments of the present application, the second communication device may be a receiving device of the back scattering signal of the tag device, and may also be a signal source (power supply device) of the tag device, such as a CPE/base station/WiFi AP, or the like.

The present application mainly considers the zero-power device or tag device that transmits the back scattering signal through RF power harvesting, and other power supply methods such as thermal energy, pressure, light energy, and the like are not excluded. The power supply signal is related to the radio frequency capability of the tag device, and has a minimum input power requirement. The power supply signal and the carrier signal may be the same, may be signals at the same frequency, or may be signals at different frequencies, depending on the radio frequency capability of the tag device (the number of supportable radio frequency channels or antennas).

In the embodiments of the present application, the back scattering communication may be communication between the first communication device and the second communication device. For example, the first communication device is a terminal device, and the second communication device is a network device, that is, the communication between the first communication device and the second communication device may be uplink and downlink communication. For another example, the first communication device is a terminal device, and the second communication device is another terminal device, that is, the communication between the first communication device and the second communication device may be sideline communication.

In a cellular network, the zero-power device has no battery to supply power and needs to obtain power for communication through power harvesting. The zero-power device may harvest environmental power such as thermal energy, light energy, kinetic energy, and the like. Moreover, the zero-power device may harvest radio frequency signals to obtain power for communication and then perform corresponding communication processes based on back scattering. Typically, a signal for power harvesting (i.e., a power supply signal) may be provided by a network device or a dedicated power node. When communication is based on scheduling, the network device needs to provide control information to schedule information transmission, which may be called a scheduling signal/trigger signal. The trigger signal and the power supply signal may be the same signal or two independent signals. When the zero-power device communicates, a carrier capable of carrying the communication is required. The carrier may be a signal independent of the power supply signal and the trigger signal, or it may be the same signal as the power supply signal, or the same signal as the trigger signal.

In the embodiments of the present application, the frequency bands of the power supply signal, the carrier signal, and the trigger signal may be completely different, completely the same, or partially the same. The power supply device continuously or intermittently transmits the power supply signal in a certain frequency band, and the zero-power device performs power harvesting. After obtaining power, the zero-power device may perform corresponding communication processes, such as measurement, channel/signal reception, channel/signal transmission, and the like.

In some embodiments, the first communication device further receives a first carrier signal transmitted by the second communication device; where the first back scattering signal is generated by modulating the first carrier signal.

That is, while receiving the first back scattering signal, the second communication device also supports transmitting the first carrier signal in the same frequency band as the first back scattering signal. Optionally, the first carrier signal may also be used as the power supply signal. Referring to FIG. 11, taking an example where the first communication device is the zero-power device and the second communication device is a base station operating in the full-duplex mode at least in the F2 frequency band, the zero-power device includes power harvesting, a simple receiver and a back scattering transmitter, and the simple receiver is, for example, an OOK/FSK receiver. The full-duplex base station transmits a signal in the F2 frequency band at the same time and at the same frequency. The downlink (DL) signal is used as the power/carrier signal, and the uplink (UL) signal is the back scattering signal after modulation of the received carrier signal. The frequency of the UL signal is F2±offset.

Exemplarily, the back scattering may support at least one of binary on-off keying (OOK) amplitude modulation, frequency-shift keying (FSK) frequency modulation, or phase-shift keying (PSK) phase modulation.

In some embodiments, the first communication device further receives a first power supply signal transmitted by the second communication device, where an operating frequency band of the first power supply signal is different from the operating frequency band of the first back scattering signal. For example, the first power supply signal is a signal in the F1 frequency band, and the first back scattering signal is a signal in the F2 frequency band.

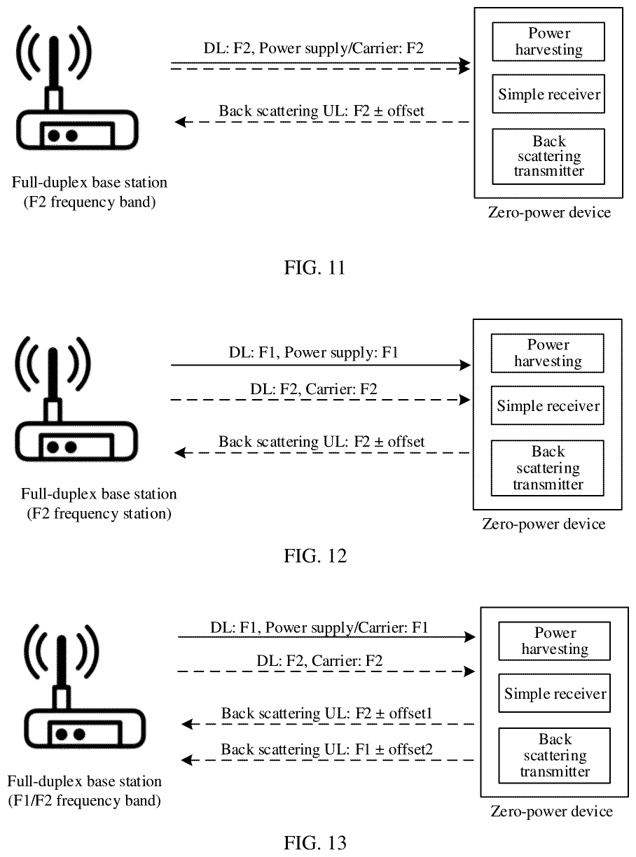

Referring to FIG. 12, taking an example where the first communication device is the zero-power device and the second communication device is the base station operating in the full-duplex mode at least in the F2 frequency band, where the zero-power device includes power harvesting, a simple receiver and a back scattering transmitter, and the simple receiver is, for example, an OOK/FSK receiver. The full-duplex base station transmits the signal in the F2 frequency band at the same time and at the same frequency, a DL signal in the F1 frequency band is used as the power supply signal (the DL signal in the F1 frequency band may be used as only the power signal), and a DL signal in the F2 frequency band is used as the carrier signal, that is, the downlink power signal and the carrier signal are separated. The UL signal is the back scattering signal after modulation of the received carrier signal, and the frequency of the UL signal is F2±offset. Optionally, the modulation method may refer to the above description.

In some embodiments, the first communication device further receives a second carrier signal transmitted by the second communication device; and the first communication device transmits a second back scattering signal to the second communication device. The second back scattering signal is generated by modulating the second carrier signal, and an operating frequency band of the second back scattering signal is different from the operating frequency band of the first back scattering signal. For example, the second carrier signal is a signal in the F1 frequency band, and the first carrier signal is a signal in the F2 frequency band.

Optionally, the second carrier signal has the same operating frequency band as the first power supply signal. As an example, the second carrier signal and the first power supply signal are the same signal, that is, this signal is used as both the power supply signal and the carrier signal.

Referring to FIG. 13, taking an example where the first communication device is the zero-power device and the second communication device is a base station operating in the full-duplex mode at least in the F1 frequency band and the F2 frequency band, the zero-power device includes power harvesting, a simple receiver and a back scattering transmitter, and the simple receiver is, for example, an OOK/FSK receiver. The full-duplex base station transmits signals on multiple frequency bands (such as the F1 frequency band and the F2 frequency band) at the same time and at the same frequency, where at least one DL signal is used as the power signal and the carrier signal (or wake up signal), and the other DL signals are used as carrier signals. For example, a DL signal in the F1 frequency band is used as the power supply/carrier signal, and a DL signal in the F2 frequency band is used as the carrier signal; the UL signal is the back scattering signal after modulation of the received carrier signal, and the frequencies of the UL signal are F2±offset1 and F1±offset2, respectively. Optionally, the modulation method may refer to the above description.

Optionally, the first back scattering signal and the second back scattering signal may be transmitted via carrier aggregation (CA), and/or the first carrier signal and the second carrier signal may be transmitted via CA to improve spectrum efficiency. The CA may be a continuous CA or a discontinuous CA, without limitation.

In some embodiments, the second communication device is used as a signal source, and the power supply or carrier signal transmitted may cause significant interference to the back scattering signal itself, i.e., self-interference of the second communication device, causing the reception of the back scattering signal to form in-band/out-of-band blocking or adjacent-band interference, resulting in the second communication device being unable to demodulate the back scattering signal, or demodulating a weaker back scattering signal.

In light of this, the present application may utilize the full-duplex capability of the second communication device and use the self-interference signal of the second communication device as the carrier signal of the back scattering signal, which can solve the interference problem between the back scattering signal and the power supply/carrier signal, and effectively resolve the receiving in-band/out-of-band blocking or adjacent-band interference of the back scattering signal, thereby better demodulating the back scattering signal.

In some embodiments, the above-mentioned first communication device also receives a second power supply signal transmitted by the second communication device, where the operating frequency of the first back scattering signal is determined according to an operating frequency of the second power supply signal (for example, the second power supply signal may also be a power supply/carrier signal, and the first back scattering signal is generated by modulating this power supply/carrier signal); and the first communication device transmits a third back scattering signal to the second communication device, where a carrier of the third back scattering signal includes a harmonic signal of the first power supply signal, that is, a harmonic signal of the first power supply signal as a reflected carrier. Here, the harmonic signal may be a self-interference signal generated when the second communication device transmits the first power supply signal. Exemplarily, the harmonic signal may be a first harmonic signal, a second harmonic signal, or a multi-harmonic signal, without limitation.

For example, the second power supply signal is a signal in the F1 frequency band, the first back scattering signal is a signal in the F1 frequency band, and the third back scattering signal is a signal in the F2 frequency band, where F2=N*F1, N is a positive integer and N>1. For example, when F1=800 MHZ, F2=1600 MHZ, that is, the third back scattering signal is a second harmonic signal of the second power supply signal.

Optionally, the second communication device operates in a half-duplex mode in an operating frequency band of the third back scattering signal. For example, the second communication device supports time division duplex (TDD) in the F2 frequency band, and the F2 frequency band may be, for example, a super uplink (SUL) frequency band. For another example, the second communication device supports frequency division duplex (FDD) in the F2 frequency band.

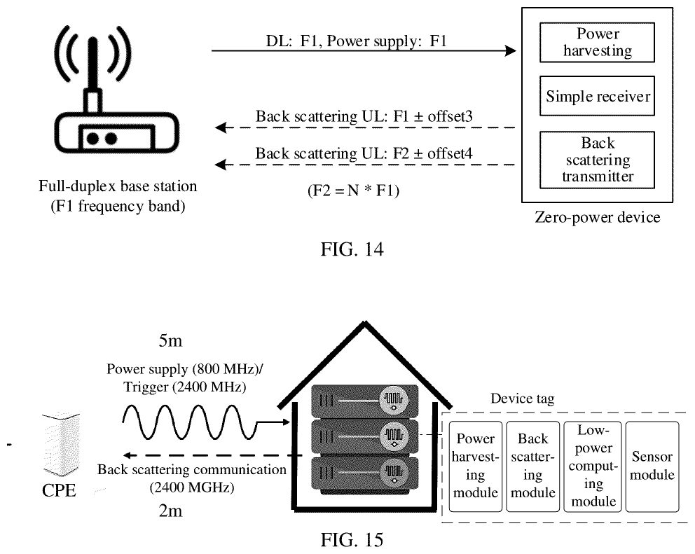

Referring to FIG. 14, taking an example where the first communication device is a zero-power device and the second communication device is a base station operating in the full-duplex mode at least in the F1 frequency band, where the zero-power device includes power harvesting, a simple receiver and a back scattering transmitter, and the simple receiver is, for example, an OOK/FSK receiver. The full-duplex base station transmits signals in the F1 frequency band in the same time and at the same frequency. For example, a DL signal in the F1 frequency band is used as a power supply signal (the DL signal in the F1 frequency band may be used as only a power supply signal); the UL receives back scattering signals in the F1 frequency band and the F2 frequency band, and the frequencies of the UL signal are F1±offset3 and F2±offset4, respectively. Here, the back scattering signal in the F2 frequency band is a multi (Nth)-harmonic signal of the power supply signal frequency. Optionally, the full-duplex base station may operate in the half-duplex mode in the F2 frequency band, such as TDD, and the F2 frequency band is the SUL frequency band. Optionally, the modulation method may refer to the above description.

Therefore, the present application may utilize the full-duplex capability of the second communication device and use the self-interference signal of the second communication device as the carrier signal of the back scattering signal, which can solve the interference problem between the back scattering signal and the power supply/carrier signal, and effectively resolve the receiving in-band/out-of-band blocking or adjacent-band interference of the back scattering signal.

Typically, the coverage of back scattering is smaller than the downlink coverage. Referring to FIG. 15, when a receiving device (such as CPE/base station/WiFi AP) for a back scattering signal of a tag device and a signal source (such as CPE/base station/WiFi AP) of the tag device are placed in the same location or in the same device, because for the tag device, the sensitivity of the carrier signal is much lower than the minimum power threshold (i.e., sensitivity) requirement of the power signal, a downlink transmission distance of the power signal or the carrier signal is unbalanced with an uplink reflection distance of the back scattering signal of the tag device (for example, the downlink transmission distance is 5 m, while the uplink reflection distance is only 2 m), and the transmission signal reaching a receiving side (such as CPE/base station/WiFi AP) is much smaller than a signal of the power signal or the carrier signal reaching the receiving side (such as CPE/base station/WiFi AP).

In the embodiments of the present application, the self-interference signal of the second communication device is used as the carrier signal of the back scattering signal, which effectively resolves the receiving in-band/out-band blocking or adjacent-band interference of the back scattering signal, and the second communication device can better demodulate the back scattering signal, and thereby the present application can enhance the uplink reflection distance of the back scattering signal and expand the practical application deployment.

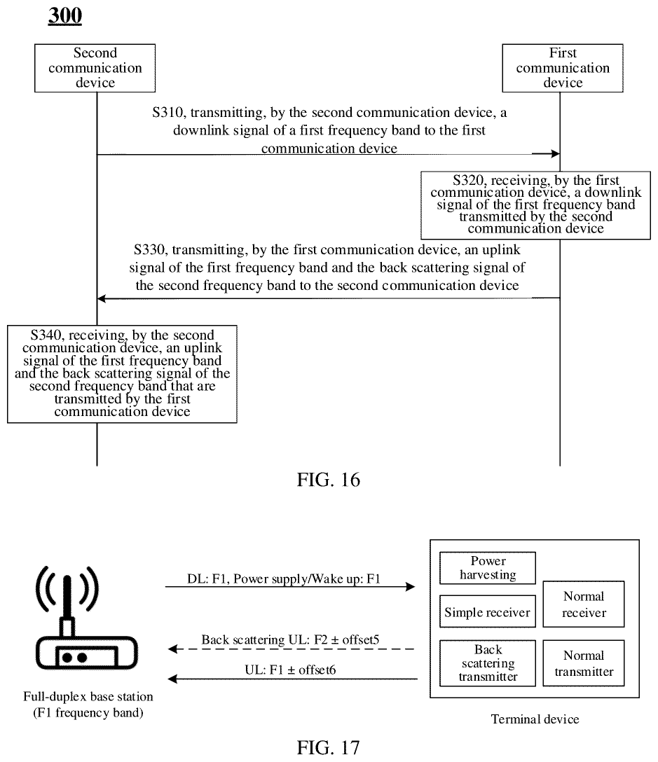

FIG. 16 is a schematic flowchart of a wireless communication method 300 according to the embodiments of the present application. As shown in FIG. 16, the wireless communication method 300 may include at least part of the contents:

S310, transmitting, by a second communication device, a downlink signal of a first frequency band to a first communication device, where the first communication device obtains power through power harvesting for communication, information harvesting and processing, and the second communication device operates in a full-duplex mode in the first frequency band; exemplarily, the downlink signal includes a power supply signal and/or a wake up signal;

S320, receiving, by the first communication device, the downlink signal of the first frequency band transmitted by the second communication device;

S330, transmitting, by the first communication device, an uplink signal of the first frequency band and a back scattering signal of the second frequency band to the second communication device; and

S340, receiving, by the second communication device, the uplink signal of the first frequency band and the back scattering signal of the second frequency band that are transmitted by the first communication device.

In the embodiments of the present application, the second communication device operates in the full-duplex mode in the first frequency band, that is, the second communication device supports simultaneous transmitting of the downlink signal and uplink signal in the first frequency band, thereby realizing a zero-power device communication mechanism under a full-duplex communication architecture, and expanding actual application deployment.

Optionally, the first communication device may operate in the full-duplex mode or a half-duplex mode in the first frequency band, without limitation.

In the embodiments of the present application, the first communication device may be a zero-power device or a tag device based on radio frequency power harvesting; and the second communication device may be a receiving device for the back scattering signal of the tag device, and may also be a signal source of the tag device, such as a CPE/base station/WiFi AP. Related reference can be made to the relevant description in FIG. 10, which will not be repeated here.

In some embodiments, the first communication device includes a normal transmitter, where a carrier of the back scattering signal includes a modulated signal transmitted by the normal transmitter.

In some embodiments, the carrier of the back scattering signal includes an interference signal (e.g., a self-interference signal) generated by the downlink signal in the first communication device (e.g., an internal circuit).

Referring to FIG. 17, taking an example where the first communication device is a terminal device and the second communication device is a base station operating in the full-duplex mode at least in the F1 frequency band, where the terminal device is an A-IoT assisted mobile Phone/UE, which may include power harvesting, a simple receiver and a back scattering transmitter, and the simple receiver is, for example, an OOK/FSK receiver. Optionally, the terminal device may also include a normal receiver and a normal transmitter. The full-duplex base station transmits signals in the F1 frequency band at the same time and at the same frequency. A DL signal in the F1 frequency band is used as the power supply signal and/or the wake up signal. The power supply signal provides a charging function for the terminal, and the wake up signal provides a wake up function for the terminal. The terminal device provides an UL signal in the F2 frequency band as a carrier signal for back scattering and transmits it to the base station, and the corresponding base station receives the back scattering signal. The frequency of the back scattering signal is F2±offset5. The terminal device further provides an UL signal in the F1 frequency band, whose frequency is F1±offset6.

Optionally, the back scattering signal may be an interference signal generated by a DL signal in the F1 frequency band in a terminal device (such as an internal circuit). As an example, the interference signal includes a harmonic signal.

As a possible implementation, a passive filter may be added to the first communication device side (e.g., UE) to filter and harvest multi-order harmonics of the corresponding reflection frequency, and the multi-order harmonics fall within the operating frequency band (e.g., the F2 frequency band) of the back scattering signal. The multi-order harmonics may be used as carriers of the back scattering signal, carrying information and reflecting it to the second communication device.

Optionally, the back scattering signal may be a modulated signal transmitted by a normal transmitter after the terminal device is woken up. Optionally, the modulation mode may be the FSK modulation, related reference of which can be made to the above description.

As an example, the F2 frequency band is the same as the frequency band of the harmonic signal of the DL signal of the F1 frequency band. As an example, the F2 frequency band may be the same as the frequency band of an intermodulation signal between the F1 frequency band and the F2 frequency band.

In some embodiments, the first communication device further receives a carrier signal of the second frequency band transmitted by the second communication device, where the back scattering signal is generated by modulating the carrier signal, and the carrier signal includes an interference signal of the downlink signal. As an example, the first frequency band may be the F1 frequency band, and the second frequency band may be the F2 frequency band. As an example, the interference signal may be the self-interference signal, such as a harmonic signal. Exemplarily, the back scattering signal is transmitted by the back scattering transmitter.

Referring to FIG. 18, taking an example where the first communication device is the terminal device, and the second communication device is the base station operating in full-duplex mode at least in the F1 frequency band and the F2 frequency band. The terminal device is the A-IoT assisted mobile Phone/UE, which may include power harvesting, a simple receiver, and a back scattering transmitter. The simple receiver may be, for example, an OOK/FSK receiver. Optionally, the terminal device may also include a normal receiver and a normal transmitter. The full-duplex base station transmits signals in the F1 frequency band at the same time and at the same frequency. A DL signal in the F1 frequency band is used as the power supply signal and/or the wake up signal. The power supply signal provides the charging function for the terminal, and the wake up signal provides the wake up function for the terminal. A self-interference signal (such as a harmonic signal) of the DL signal in the F1 frequency band is also transmitted to the terminal device as the carrier signal. The self-interference signal is in the F2 frequency band. The terminal device may perform the FSK modulation on the carrier signal and transmit a back scattering signal after frequency offset to the base station. Correspondingly, the base station receives the back scattering signal. The frequency of the back scattering signal is F2±offset7. The terminal device also provides an UL signal in the F1 frequency band, whose frequency is F1±offset8.

In some embodiments, there is a frequency offset between the back scattering signal and the interference signal. The ability of the second communication device to eliminate interference of the back scattering signal is related to the frequency offset. Exemplarily, the second communication device shifts the carrier signal frequency to an adjacent-band through the FSK modulation, and there is a certain frequency offset or interval between the back scattering signal and the useful received signal of the second communication device, thereby achieving the purpose of avoiding interference. The frequency offset is greater than or equal to a unit of frequency protection band or a bandwidth of an occupied channel, such as 5 MHZ.

Therefore, the present application may utilize the full-duplex capability of the second communication device, and use the self-interference signal of the second communication device or the self-interference signal of the first communication device as the carrier signal of the back scattering signal, which can solve the interference problem between the back scattering signal and the power supply/carrier signal, and effectively resolve the in-band/out-of-band blocking or adjacent-band interference of the back scattering signal.

Furthermore, the self-interference signal of the second communication device or the self-interference signal of the first communication device is used as the carrier signal of the back scattering signal, which effectively resolves the receiving in-band/out-band blocking or adjacent-band interference of the back scattering signal. Moreover, the second communication device can better demodulate the back scattering signal. Therefore, the present application can enhance the uplink reflection distance of the back scattering signal and expand the practical application deployment.

Taking an example where the second communication device is the full-duplex base station and the first communication device is the UE operating in the half-duplex mode (i.e., a half-duplex UE), the back scattering mechanism under the full-duplex communication system is as follows:

UL time slot: in which the self-interference signal (F2 frequency band, harmonic signal) of the UL signal in the F1 frequency band is used as the carrier of the back scattering signal. When the OOK modulation is adopted, the carrier of the back scattering signal is in the F2 frequency band; and when the FSL modulation is adopted, the carrier of the back scattering signal is F2±offset/1 CBW, where the CBW refers to a channel bandwidth on the UE side.

DL time slot: in which the DL signal (such as the F2 frequency band in a specific frequency band combination) is used as the carrier of the back scattering signal. When the OOK modulation is adopted, the carrier of the back scattering signal is in the F2 frequency band; and when the FSL modulation is used, the carrier of the back scattering signal is F2±offset/1 CBW.

In addition, the full-duplex base station realizes full-duplex at the same time and at the same frequency, has the CA capability or simultaneous reception capability of the F1+F2 frequency band combination, and has the downlink transmission capability of the F2 frequency band. Here, the F1+F2 frequency band may be SUL (F1)+TDD (OOK, F2)/FDDband (FSK, such as F2 DL, F2±offset/1 CBW UL):
F1 SUL+F2 TDD; and
F1 SUL+(F2±offset) FDD.

The half-duplex UE carries the back scattering transmitter or reflector function:
F2 DL, F2 UL, F1 UL; and
F2 UL or (F2±offset), which may be transmitted by a normal transmitter or a back scattering transmitter.

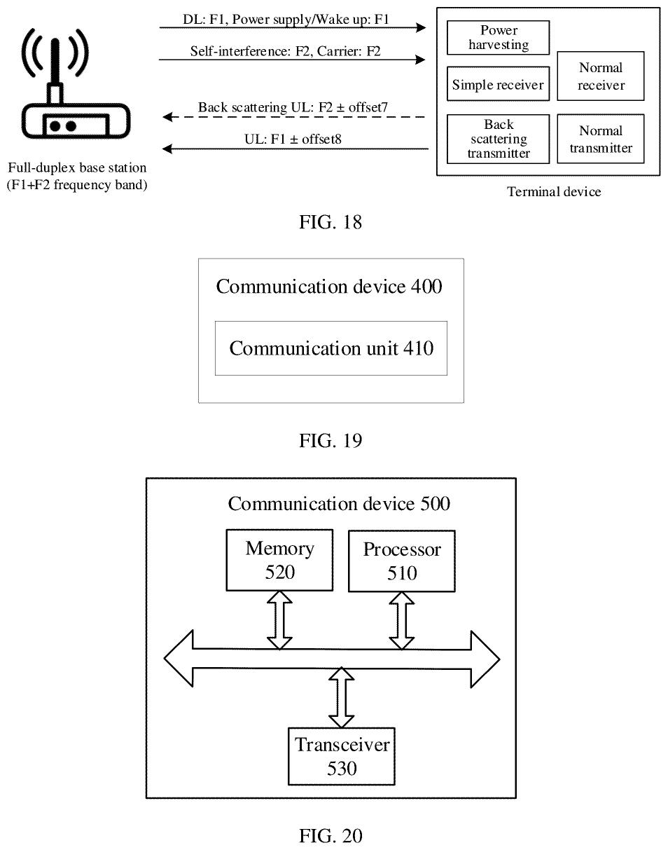

The above, in combination with FIGS. 10 to 18, describes in detail the method embodiments of the present application. The following, in combination with FIGS. 19 to 22, describes in detail the device embodiments of the present application. It should be understood that the device embodiments and the method embodiments correspond to each other, and similar descriptions may refer to that of the method embodiments.

FIG. 19 shows a schematic block diagram of a communication device 400 according to the embodiments of the present application, where the communication device 400 includes a communication unit 410.

In some embodiments, the communication device 400 is a first communication device, and the communication unit 410 is configured to transmit a first back scattering signal to a second communication device. The first communication device obtains power through power harvesting for communication, information harvesting and processing, and the second communication device operates in a full-duplex mode in an operating frequency band of the first back scattering signal.

Optionally, the communication unit 410 is further configured to receive a first carrier signal transmitted by the second communication device, where the first back scattering signal is generated by modulating the first carrier signal.

Optionally, the communication unit 410 is further configured to receive a first power supply signal transmitted by the second communication device, where an operating frequency band of the first power supply signal is different from the operating frequency band of the first back scattering signal.

Optionally, the communication unit 410 is further configured to: receive a second carrier signal transmitted by the second communication device; and
transmit a second back scattering signal to the second communication device, where the second back scattering signal is generated by modulating the second carrier signal, and an operating frequency band of the second back scattering signal is different from the operating frequency band of the first back scattering signal.

Optionally, the first back scattering signal and the second back scattering signal are transmitted via carrier aggregation.

Optionally, the first carrier signal and the second carrier signal are transmitted via carrier aggregation.

Optionally, the second carrier signal has the same operating frequency band as the first power supply signal.

Optionally, the communication unit 410 is further configured to: receive a second power supply signal transmitted by the second communication device, where the operating frequency of the first back scattering signal is determined according to an operating frequency of the second power supply signal; and
transmit a third back scattering signal to the second communication device, where a carrier of the third back scattering signal includes a harmonic signal of the first power supply signal.

Optionally, the second communication device operates in a half-duplex mode in an operating frequency band of the third back scattering signal.

Optionally, the first communication device includes a back scattering transmitter, where the first back scattering signal is transmitted by the back scattering transmitter.

It should be understood that the communication device 400 in these embodiments may correspond to the first communication device in the method embodiments of the present application, and the above-mentioned and other operations and/or functions of each unit in the communication device 400 are respectively for implementing the corresponding process of the first communication device in the method 200 shown in FIG. 10, which will not be repeated here for the sake of brevity.

In some embodiments, the communication device 400 is a second communication device, and the communication unit 410 is configured to receive a first back scattering signal transmitted by the first communication device;
where the first communication device obtains power through power harvesting for communication, information harvesting and processing, and the second communication device operates in a full-duplex mode in an operating frequency band of the first back scattering signal.

Optionally, the communication unit 410 is further configured to transmit a first carrier signal to the first communication device, where the first back scattering signal is generated by modulating the first carrier signal.

Optionally, the communication unit 410 is further configured to transmit a first power supply signal to the first communication device, where an operating frequency band of the first power supply signal is different from the operating frequency band of the first back scattering signal.

Optionally, the communication unit 410 is further configured to: transmit a second carrier signal to the first communication device; and
receive a second back scattering signal transmitted by the first communication device, where the second back scattering signal is generated by modulating the second carrier signal, and an operating frequency band of the second back scattering signal is different from the operating frequency band of the first back scattering signal.

Optionally, the first back scattering signal and the second back scattering signal are transmitted via carrier aggregation.

Optionally, the first carrier signal and the second carrier signal are transmitted via carrier aggregation.

Optionally, the second carrier signal has the same operating frequency band as the first power supply signal.

Optionally, the communication unit 410 is further configured to: transmit a second power supply signal to the first communication device, where the operating frequency of the first back scattering signal is determined according to an operating frequency of the second power supply signal; and
receive a third back scattering signal transmitted by the first communication device, where a carrier of the third back scattering signal includes a harmonic signal of the first power supply signal.

Optionally, the second communication device operates in a half-duplex mode in an operating frequency band of the third back scattering signal.

Optionally, the first communication device includes a back scattering transmitter, where the first back scattering signal is transmitted by the back scattering transmitter.

It should be understood that the communication device 400 in these embodiments may correspond to the second communication device in the method embodiments of the present application, and the above-mentioned and other operations and/or functions of each unit in the communication device 400 are respectively for implementing the corresponding process of the second communication device in the method 200 shown in FIG. 10, which will not be repeated here for the sake of brevity.

In some embodiments, the communication device 400 is a first communication device, and the communication unit 410 is configured to: receive a downlink signal of a first frequency band transmitted by a second communication device; and
transmit an uplink signal of the first frequency band and a back scattering signal of a second frequency band to the second communication device;
where the first communication device obtains power through power harvesting for communication, information harvesting and processing, and the second communication device operates in a full-duplex mode in the first frequency band.

Optionally, the first communication device includes a normal transmitter, where a carrier of the back scattering signal includes a modulated signal transmitted by the normal transmitter.

Optionally, the carrier of the back scattering signal includes an interference signal generated by the downlink signal in the first communication device.

Optionally, the communication unit 410 is further configured to receive a carrier signal of the second frequency band transmitted by the second communication device, where the back scattering signal is generated by modulating the carrier signal, and the carrier signal includes an interference signal of the downlink signal.

Optionally, there is a frequency offset between the back scattering signal and the interference signal.

Optionally, the frequency offset is greater than or equal to a unit of a frequency guard band or a bandwidth of an occupied channel.

Optionally, the first communication device includes a back scattering transmitter, where the back scattering signal is transmitted by the back scattering transmitter.

Optionally, the interference signal includes a harmonic signal.

Optionally, the downlink signal includes a power supply signal and/or a wake up signal.

It should be understood that the communication device 400 in these embodiments may correspond to the first communication device in the method embodiments of the present application, and the above-mentioned and other operations and/or functions of each unit in the communication device 400 are respectively for implementing the corresponding process of the first communication device in the method 300 shown in FIG. 16, which will not be repeated here for the sake of brevity.

In some embodiments, the communication device 400 is a second communication device, and the communication unit 410 is configured to: transmit a downlink signal of a first frequency band to a first communication device; and
receive an uplink signal of the first frequency band and a back scattering signal of a second frequency band transmitted by the first communication device;
where the first communication device obtains power through power harvesting for communication, information harvesting and processing, and the second communication device operates in a full-duplex mode in the first frequency band.

Optionally, the first communication device includes a normal transmitter, where a carrier of the back scattering signal includes a modulated signal transmitted by the normal transmitter.

Optionally, the carrier of the back scattering signal includes an interference signal generated by a downlink signal in the first communication device.

Optionally, the communication unit 410 is further configured to transmit a carrier signal of the second frequency band to the first communication device, where the back scattering signal is generated by modulating the carrier signal, and the carrier signal includes an interference signal of the downlink signal.

Optionally, there is a frequency offset between the back scattering signal and the interference signal.

Optionally, the frequency offset is greater than or equal to a unit of a frequency guard band or a bandwidth of an occupied channel.

Optionally, the first communication device includes a back scattering transmitter, where the back scattering signal is transmitted by the back scattering transmitter.

Optionally, the interference signal includes a harmonic signal.

Optionally, the downlink signal includes a power supply signal and/or a wake up signal.

It should be understood that the communication device 400 in these embodiments may correspond to the second communication device in the method embodiments of the present application, and the above-mentioned and other operations and/or functions of each unit in the communication device 400 are respectively for implementing the corresponding processes of the second communication device in the method 300 shown in FIG. 16, which will not be repeated here for the sake of brevity.

In some embodiments, the communication unit may be a communication interface or a transceiver, or an input/output interface of a communication chip or a system on chip. The processing unit mentioned above may be one or more processors.

FIG. 20 is a schematic structural diagram of a communication device 500 provided according to the embodiments of the present application. The communication device 500 shown in FIG. 20 includes a processor 510, which may call a computer program from a memory and run the computer program to implement the method in the embodiments of the present application.

In some embodiments, as shown in FIG. 20, the communication device 500 may further include a memory 520. The processor 510 may call a computer program from the memory 520 and run the computer program to implement the method in the embodiments of the present application.

The memory 520 may be a separate device independent of the processor 510, or may be integrated into the processor 510.

In some embodiments, as shown in FIG. 20, the communication device 500 may further include a transceiver 530. The processor 510 may control the transceiver 530 to communicate with other devices, and for example, may control the transceiver 530 to transmit information or data to other devices, or receive information or data transmitted by other devices.

The transceiver 530 may include a transmitter and a receiver. The transceiver 530 may further include an antenna, and there may be one or more antennas.

In some embodiments, the communication device 500 may be the first communication device of the embodiments of the present application, and the communication device 500 may implement the corresponding processes implemented by the first communication device in each method in the embodiments of the present application, which will not be described in detail here for the sake of brevity.

In some embodiments, the communication device 500 may be the second communication device of the embodiments of the present application, and the communication device 500 may implement the corresponding processes implemented by the second communication device in each method in the embodiments of the present application, which will not be described again for the sake of brevity.

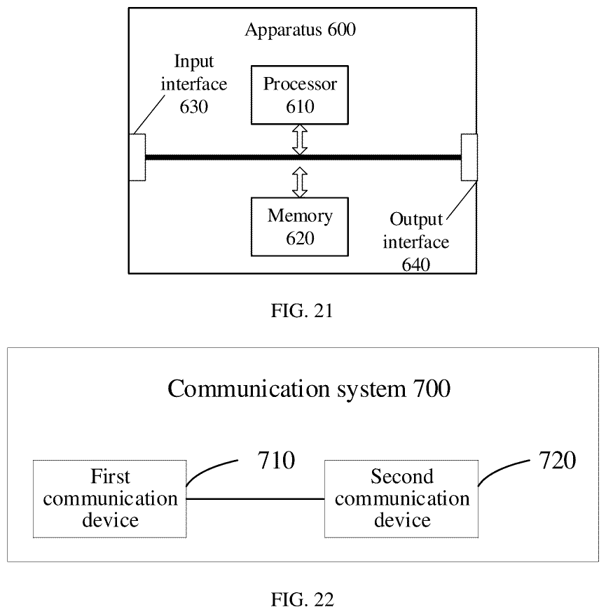

FIG. 21 is a schematic structural diagram of an apparatus of the embodiments of the present application. The apparatus 600 shown in FIG. 21 includes a processor 610, and the processor 610 may call a computer program from a memory and run the computer program to implement the method in the embodiments of the present application.

In some embodiments, as shown in FIG. 21, the apparatus 600 may further include a memory 620. The processor 610 may call a computer program from the memory 620 and run the computer program to implement the method in the embodiments of the present application.

The memory 620 may be a separate device independent of the processor 610, or may be integrated into the processor 610.

In some embodiments, the apparatus 600 may further include an input interface 630. The processor 610 may control the input interface 630 to communicate with other devices or chips, and for example, may control the input interface 630 to obtain information or data transmitted by other devices or chips.

In some embodiments, the apparatus 600 may further include an output interface 640. The processor 610 may control the output interface 640 to communicate with other devices or chips, and for example, may control the output interface 640 to output information or data to other devices or chips.

In some embodiments, the apparatus may be applied to the first communication device in the embodiments of the present application, and the apparatus may implement the corresponding processes implemented by the first communication device in each method in the embodiments of the present application, which will not be described in detail here for the sake of brevity.

In some embodiments, the apparatus may be applied to the second communication device in the embodiments of the present application, and the apparatus may implement the corresponding processes implemented by the second communication device in each method in the embodiments of the present application, which will not be described in detail here for the sake of brevity.

In some embodiments, the apparatus mentioned in the embodiments of the present application may also be a chip. For example, it may be a system-level chip, a system chip, a chip system, a system-on-chip (SoC) chip, or the like.

FIG. 22 is a schematic block diagram of a communication system 700 provided by the embodiments of the present application. As shown in FIG. 22, the communication system 700 includes a first communication device 710 and a second communication device 720.

The first communication device 710 may be configured to implement the corresponding functions implemented by the first communication device in the above method, and the second communication device 720 may be configured to implement the corresponding functions implemented by the second communication device in the above method, which will not be repeated here for the sake of brevity.

It should be understood that the processor of the embodiments of the present application may be an integrated circuit chip with signal processing capabilities. In the implementation process, each step of the above method embodiments may be completed by an integrated logic circuit of hardware in a processor or an instruction in software form. The above-mentioned processor may be a general purpose processor, a digital signal processor (DSP), an application specific integrated circuit (ASIC), a field programmable gate array (FPGA) or other programmable logic devices, a discrete gate or transistor logic device, or a discrete hardware component, which can implement or execute the various methods, steps and logic block diagrams disclosed in the embodiments of the present application. The general purpose processor may be a microprocessor, or the processor may be any conventional processor or the like. The steps of the method disclosed in the embodiments of the present application may be directly implemented as being executed by a hardware decoding processor, or may be implemented by a combination of hardware and software modules in the decoding processor. The software module may be located in a random access memory, a flash memory, a read-only memory, a programmable read-only memory, an electrically erasable programmable memory, a register, or another mature storage medium in the art. The storage medium is located in the memory, and the processor reads the information in the memory and completes the steps of the above method in combination with its hardware.

It can be understood that the memory in the embodiments of the present application may be a volatile memory or a non-volatile memory, or may include both volatile and non-volatile memories. Here, the non-volatile memory may be a read-only memory (ROM), a programmable ROM (PROM), an erasable PROM (EPROM), an electrically EPROM (EEPROM), or a flash memory. The volatile memory may be a random access memory (RAM), which acts as external cache memory. By way of example and not limitation, many forms of RAM are available, such as a static RAM (SRAM), a dynamic RAM (DRAM), a synchronous DRAM (SDRAM), a double data rate SDRAM (DDR SDRAM), an enhanced SDRAM (ESDRAM), a synch link DRAM (SLDRAM), and a direct rambus RAM (DR RAM). It should be noted that the memories of the systems and methods described herein are intended to include, without being limited to, these and any other suitable types of memories.

It should be understood that the above-mentioned memory is exemplary but not limiting illustration, e.g., the memory in the embodiments of the present application may also be a static RAM (SRAM), a dynamic RAM (DRAM), a synchronous DRAM (SDRAM), a double data rate SDRAM (DDR SDRAM), an enhanced SDRAM (ESDRAM), a synch link DRAM (SLDRAM), a Direct Rambus RAM (DR RAM), or the like. That is, the memories in the embodiments of the present application are intended to include but are not limited to these and any other suitable types of memories.

The embodiments of the present application further provide a non-transitory computer-readable storage medium for storing a computer program.

In some embodiments, the non-transitory computer-readable storage medium may be applied to the first communication device in the embodiments of the present application, and the computer program enables the computer to perform the corresponding processes implemented by the first communication device in each method in the embodiments of the present application, which will not be repeated here for the sake of brevity.

In some embodiments, the non-transitory computer-readable storage medium may be applied to the second communication device in the embodiments of the present application, and the computer program enables the computer to perform the corresponding processes implemented by the second communication device in each method in the embodiments of the present application, which will not be repeated here for the sake of brevity.

The embodiments of the present application further provide a computer program product, including computer program instructions.

In some embodiments, the computer program product may be applied to the first communication device in the embodiments of the present application, and the computer program instructions enable the computer to perform the corresponding processes implemented by the first communication device in each method in the embodiments of the present application, which will not be repeated here for the sake of brevity.

In some embodiments, the computer program product may be applied to the second communication device in the embodiments of the present application, and the computer program instructions enable the computer to perform the corresponding processes implemented by the second communication device in each method in the embodiments of the present application, which will not be repeated here for the sake of brevity.

The embodiments of the present application further provide a computer program.

In some embodiments, the computer program may be applied to the first communication device in the embodiments of the present application. When being executed on a computer, the computer program enables the computer to perform the corresponding processes implemented by the first communication device in each method in the embodiments of the present application, which will not be repeated here for the sake of brevity.

In some embodiments, the computer program may be applied to the second communication device in the embodiments of the present application. When being executed on a computer, the computer program enables the computer to perform the corresponding processes implemented by the second communication device in each method in the embodiments of the present application, which will not be repeated here for the sake of brevity.

Those skilled in the art will appreciate that the units and algorithm steps of each example described in conjunction with the embodiments disclosed herein may be implemented by electronic hardware, or a combination of computer software and electronic hardware. Whether these functions are performed in hardware or software depends on the application and design constraints of the technical solution. Professional technicians may use different methods to implement the described functions for each application, but such implementation should not be considered to be beyond the scope of the present application.

Those skilled in the art may clearly understand that, for the convenience and brevity of description, the operating processes of the systems, apparatuses/devices and units described above may refer to the corresponding processes in the aforementioned method embodiments and will not be repeated here.

In several embodiments provided in the present application, it should be understood that the disclosed systems, apparatuses/devices, and methods may be implemented in other ways. For example, the apparatuses/device embodiments described above are merely illustrative. For example, the division of the units is merely a logical function division. There may be other division methods in actual implementation. For example, multiple units or components may be combined or integrated into another system, or some features may be ignored or not executed. Another point is that the mutual coupling or direct coupling or communication connection shown or discussed may be an indirect coupling or communication connection through some interfaces, devices or units, which may be electrical, mechanical or other forms.

Units described as separate components may or may not be physically separated; and components shown as units may or may not be physical units, that is, these components may be located in one place or may be distributed over multiple network units. Some or all of the units may be selected according to actual needs to achieve the purpose of the solution of the embodiments.

In addition, each functional unit in each embodiment of the present application may be integrated into one processing unit, or each functional unit may exist physically separately, or two or more functional units may be integrated into one processing unit.

The functions addressed above may be stored in a non-transitory computer-readable storage medium if implemented in the form of software functional units and sold or used as independent products. Based on such an understanding, the technical solutions of the present application may essentially be embodied in the form of a software product, or the part that contributes to the prior art, or the part of the technical solution. The computer software product is stored in a storage medium and includes a number of instructions for causing a computer device (which may be a personal computer, a server, a network device, or the like) to execute all or part of the steps of the method described in each embodiment of the present application. The aforementioned storage mediums include: a U disk, a mobile hard disk, a read-only memory (ROM), a random access memory (RAM), a disk or optical disk, and other mediums that may store program code.

The above content is only exemplary implementations of the present application, but the protection scope of the present application is not limited thereto, and any skilled familiar with this technical field may easily think of changes or substitutions within the technical scope disclosed in the present application, which should be all covered within the protection scope of the present application. Therefore, the protection scope of the present application should be subject to the protection scope of the claims.

What is claimed is:

1. A wireless communication method, comprising:
transmitting, by a first communication device, a first back scattering signal to a second communication device;
wherein the first communication device obtains power through power harvesting for communication, information harvesting and processing, and the second communication device operates in a full-duplex mode in an operating frequency band of the first back scattering signal.

2. The method according to claim 1, further comprising:
receiving, by the first communication device, a first carrier signal transmitted by the second communication device;
wherein the first back scattering signal is generated by modulating the first carrier signal.

3. The method according to claim 2, further comprising:
receiving, by the first communication device, a first power supply signal transmitted by the second communication device, wherein an operating frequency band of the first power supply signal is different from the operating frequency band of the first back scattering signal.

4. The method according to claim 3, further comprising:
receiving, by the first communication device, a second carrier signal transmitted by the second communication device; and
transmitting, by the first communication device, a second back scattering signal to the second communication device, wherein the second back scattering signal is generated by modulating the second carrier signal, and an operating frequency band of the second back scattering signal is different from the operating frequency band of the first back scattering signal.

5. The method according to claim 4, wherein the first back scattering signal and the second back scattering signal are transmitted via carrier aggregation;
the first carrier signal and the second carrier signal are transmitted via carrier aggregation.

6. The method according to claim 1, further comprising:
receiving, by the first communication device, a second power supply signal transmitted by the second communication device, wherein an operating frequency of the first back scattering signal is determined according to an operating frequency of the second power supply signal; and
transmitting, by the first communication device, a third back scattering signal to the second communication device, wherein a carrier of the third back scattering signal comprises a harmonic signal of the first power supply signal.

7. The method according to claim 6, wherein the second communication device operates in a half-duplex mode in an operating frequency band of the third back scattering signal.

8. The method according to claim 1, wherein the first communication device comprises a back scattering transmitter, wherein the first back scattering signal is transmitted by the back scattering transmitter.

9. A first communication device, comprising: a transceiver, a processor and a memory, wherein the transceiver is configured to transmit and receive a signal, the memory is configured to store a computer program, and the processor is configured to call and run the computer program stored in the memory, to cause the first communication device to perform:
transmitting a first back scattering signal to a second communication device;
wherein the first communication device obtains power through power harvesting for communication, information harvesting and processing, and the second communication device operates in a full-duplex mode in an operating frequency band of the first back scattering signal.

10. The first communication device according to claim 9, wherein the first communication device further performs:
receiving a first carrier signal transmitted by the second communication device;
wherein the first back scattering signal is generated by modulating the first carrier signal.

11. The first communication device according to claim 10, wherein the first communication device further performs:
receiving a first power supply signal transmitted by the second communication device, wherein an operating frequency band of the first power supply signal is different from the operating frequency band of the first back scattering signal.

12. The first communication device according to claim 11, wherein the first communication device further performs:
receiving a second carrier signal transmitted by the second communication device; and
transmitting a second back scattering signal to the second communication device, wherein the second back scattering signal is generated by modulating the second carrier signal, and an operating frequency band of the second back scattering signal is different from the operating frequency band of the first back scattering signal.

13. The first communication device according to claim 12, wherein the first back scattering signal and the second back scattering signal are transmitted via carrier aggregation;
the first carrier signal and the second carrier signal are transmitted via carrier aggregation.

14. The first communication device according to claim 9, wherein the first communication device further performs:
receiving a second power supply signal transmitted by the second communication device, wherein an operating frequency of the first back scattering signal is determined according to an operating frequency of the second power supply signal; and
transmitting a third back scattering signal to the second communication device, wherein a carrier of the third back scattering signal comprises a harmonic signal of the first power supply signal.

15. The first communication device according to claim 14, wherein the second communication device operates in a half-duplex mode in an operating frequency band of the third back scattering signal.

16. The first communication device according to claim 9, wherein the first communication device comprises a back scattering transmitter, wherein the first back scattering signal is transmitted by the back scattering transmitter.

17. A second communication device, comprising: a transceiver, a processor and a memory, wherein the transceiver is configured to transmit and receive a signal, the memory is configured to store a computer program, and the processor is configured to call and run the computer program stored in the memory, to cause the second communication device to perform:
receiving a first back scattering signal transmitted by a first communication device;
wherein the first communication device obtains power through power harvesting for communication, information harvesting and processing, and the second communication device operates in a full-duplex mode in an operating frequency band of the first back scattering signal.

18. The second communication device according to claim 17, wherein the second communication device further performs:
transmitting a first power supply signal to the first communication device, wherein an operating frequency band of the first power supply signal is different from the operating frequency band of the first back scattering signal.

19. The second communication device according to claim 18, wherein the second communication device further performs:
transmitting a second carrier signal to the first communication device; and
receiving a second back scattering signal transmitted by the first communication device, wherein the second back scattering signal is generated by modulating the second carrier signal, and an operating frequency band of the second back scattering signal is different from the operating frequency band of the first back scattering signal.

20. The second communication device according to claim 19, wherein the first back scattering signal and the second back scattering signal are transmitted via carrier aggregation;
the first carrier signal and the second carrier signal are transmitted via carrier aggregation.
